(19) United States
(12) Patent Application Publication
(10) Pub. No.: US 2018/0114304 A1
(43) Pub. Date: Apr. 26, 2018

(54) WORKPIECE CONDUCTIVE FEATURE INSPECTING METHOD AND WORKPIECE CONDUCTIVE FEATURE INSPECTING SYSTEM

(71) Applicants: Inventec (Pudong) Technology Corporation, Shanghai (CN); INVENTEC CORPORATION, TAIPEI CITY (TW)

(72) Inventor: Yong-Cheng CHEN, TAIPEI CITY (TW)

(21) Appl. No.: 15/472,265

(22) Filed: Mar. 28, 2017

(30) Foreign Application Priority Data
Oct. 20, 2016 (CN) 201610914663.3

(51) Int. Cl. G06T 7/00

(52) U.S. Cl. CPC G06T 7/001; G06T 2207/30152; G06T 2207/30141

(57) ABSTRACT

A method for inspecting conductive features of a workpiece includes videographing a part of a workpiece having a plurality of conductive features to capture a workpiece sub-image, in which the workpiece sub-image has one or more feature images respectively corresponding to one or more of the conductive features; finding predetermined feature points corresponding to a part of the feature images among a plurality of predetermined feature points based on the predetermined feature points in a standard workpiece image to locate an area of the standard workpiece image corresponding to the workpiece sub-image; and comparing the corresponding area of the standard workpiece image with the workpiece sub-image, if one or more of the predetermined feature points within the area differ from the one or more first feature images, the workpiece is determined to be a defective workpiece.

### RELATED APPLICATIONS

This application claims priority to Chinese Application Serial Number 201610914663.3, filed Oct. 20, 2016, which is herein incorporated by reference.

### BACKGROUND

### Field of Invention

The present invention relates to a method for inspecting conductive features of a workpiece and a system for inspecting conductive features of a workpiece. More particularly, the present invention relates to a method for inspecting conductive features of a workpiece and a system for inspecting conductive features of a workpiece applied to an inspection process in a production line.

### Description of Related Art

Traditionally, a large amount of manpower is required when soldering electronic components on circuit boards or other electronic products. In addition to the process used for soldering, it is more difficult to identify the soldering points formed by soldering. Therefore, it is necessary to use more manpower for quality control to check whether soldering points on circuit boards or other electronic products after being soldered have defects so as to ensure the quality of the circuit boards or other electronic products. It is true that with the popularity of automated production lines, most of the soldering processes have been automated through machinery, for example, through a wave-soldering machine, etc. As a result, not only can the manpower be saved, but the automatic manufacturing performed by machinery can also take on more complex and repetitive tasks and avoid mistakes caused by fatigue. However, during the process of manufacturing, it is inevitable to generate defects, and thus manpower is still required to carry out the inspection tasks. With the soldering of the circuit boards or other electronic products becoming increasingly complex, the inspection tasks, which yet can be carried out by manpower, still tend to have omissions. Additionally, the inspection tasks carried out by manpower can not cope with the assembly production lines that have a heavier capacity and faster rate.

In addition, currently there are technologies that use automated optical inspecting systems and methods to examine for defects. The most important thing in the inspection process is to find the object to be inspected. At present, the adopted approaches are mostly writing specific algorithms for objects. However, this method consumes a lot of time in the inspection for each feature, and can not quickly increase the inspection categories for various types of dual in-line packages (DIPs). In addition to that, the quality of trays differs so the images thus captured also differ. Some features will make the programs mistakenly judge the inspection points, which causes unnecessary manual re-examination and waste of inspection time.

For the forgoing reasons, there is a need to solve the above-mentioned problems by providing a method for inspecting conductive features of a workpiece and a system for inspecting conductive features of a workpiece, which is also an objective that the industry is eager to achieve.

### SUMMARY

One aspect of the present invention is to provide a method for inspecting conductive features of a workpiece. According to the present invention method, the standard workpiece image is divided into the plurality of standard workpiece sub-images having a smaller area and less predetermined feature points, and the standard workpiece sub-images are compared with the workpiece sub-image that is obtained by capturing image of part of the workpiece and has the features images corresponding to the conductive features. Therefore, the computing amount and computing time for comparing the features images and the predetermined feature points can be reduced. In addition, the portions that have been located can be used as an anchor in subsequent comparison so as to generate a comparison result. As a result, the burden of the computing device and the length of computing time can be reduced. Even more, the present invention method can be applied to the production line that has a faster rate.

A method for inspecting conductive features of a workpiece is provided. The method comprises: videographing a first part of a workpiece having a plurality of conductive features to capture a first workpiece sub-image, wherein the first workpiece sub-image has one or more first feature images respectively corresponding to one or more of the conductive features; finding predetermined feature points corresponding to at least part of the one or more first feature images among a plurality of predetermined feature points based on the plurality of predetermined feature points in a standard workpiece image to locate a first area of the standard workpiece image corresponding to the first workpiece sub-image; and comparing the first area of the standard workpiece image with the first workpiece sub-image, if one or more of the predetermined feature points within the first area differ from the one or more first feature images, the workpiece being determined to be a defective workpiece.

In the foregoing, the step of finding the predetermined feature points corresponding to the at least part of the one or more first feature points among the plurality of predetermined feature points comprises: dividing the standard workpiece image into a plurality of standard workpiece sub-images, wherein each of the standard workpiece sub-images has one or more of the predetermined feature points; and comparing each of the standard workpiece sub-images with the first workpiece sub-image to locate the first area of the standard workpiece image corresponding to the first workpiece sub-image.

In the foregoing, the first workpiece sub-image has the one or more first feature images, and each of the standard workpiece sub-images has the one or more of the predetermined feature points. The step of finding the predetermined feature points corresponding to the at least part of the one or more first feature points among the plurality of predetermined feature points comprises: setting a first fixed point in the first workpiece sub-image, and respectively calculating relative to the first fixed point to obtain a plurality of coordinates of first feature images corresponding to the first feature images; setting a second fixed point in each of the standard workpiece sub-images, and respectively calculating relative to the second fixed point to obtain a plurality of coordinates of predetermined feature points corresponding to the one or more of the predetermined feature points in each of the standard workpiece sub-images; and obtaining at least one of the standard workpiece sub-images that overlaps the first workpiece sub-image based on relative relationships between the coordinates of first feature images and relative relationships between the coordinates of predetermined feature points.

In the foregoing, the step of finding the predetermined feature points corresponding to the at least part of the one or more first feature points among the plurality of predetermined feature points comprises: identifying profiles of the one or more first feature images to respectively obtain one or more first feature configurations; generating one or more second feature configurations respectively based on profiles of the one or more of the predetermined feature points of each of the standard workpiece sub-images; and obtaining at least one of the standard workpiece sub-images that overlaps the first workpiece sub-image based on the one or more first feature configurations and the one or more second feature configurations.

In the foregoing, the method for inspecting conductive features of the workpiece further comprises: videographing parts of the workpiece other than the first part to capture at least one second workpiece sub-image, wherein the second workpiece sub-image has one or more second feature images respectively corresponding to one or more of the conductive features located outside the first part; locating a second area of the standard workpiece image corresponding to the second workpiece sub-image based on the first workpiece sub-image corresponding to the first area of the standard workpiece image; and comparing the second area of the standard workpiece image with the second workpiece sub-image, if one or more of the predetermined feature points within the second area differ from the one or more second feature images, the workpiece being determined to be a defective workpiece.

The invention provides a system for inspecting conductive features of a workpiece. The system comprises at least one workpiece, at least one video capture tool, and a computing device. The workpiece has a plurality of conductive features. The video capture tool has a field of view. The video capture tool is so disposed that a first workpiece sub-image is captured when the workpiece enters into the field of view. The first workpiece sub-image has one or more first feature images respectively corresponding to one or more of the conductive features. The computing device finds predetermined feature points corresponding to at least part of the one or more first feature images among a plurality of predetermined feature points based on the plurality of predetermined feature points in a standard workpiece image to locate a first area of the standard workpiece image corresponding to the first workpiece sub-image. The computing device further compares the first area of the standard workpiece image with the first workpiece sub-image. If one or more of the predetermined feature points within the first area differ from the one or more first feature images, the workpiece is determined to be a defective workpiece.

In the foregoing, the system for inspecting conductive features of the workpiece further comprises a production line. The production line has a production direction. The workpiece is placed on the production line and advances in the production direction. The video capture tool captures at least one second workpiece sub-image of the workpiece in the field of view in chronological order. The second workpiece sub-image has one or more second feature images. The second workpiece sub-image is at least partially different from the first workpiece sub-image. The computing device locates a second area of the standard workpiece image corresponding to the second workpiece sub-image based on the first workpiece sub-image corresponding to the first area of the standard workpiece image, and compares the second area of the standard workpiece image with the second workpiece sub-image. If one or more of the predetermined feature points within the second area differ from the one or more second feature images, the workpiece is determined to be a defective workpiece.

In the foregoing, the computing device further divides the standard workpiece image into a plurality of standard workpiece sub-images. Each of the standard workpiece sub-images has one or more of the predetermined feature points. After that, the computing device compares each of the standard workpiece sub-images with the first workpiece sub-image to locate the first area of the standard workpiece image corresponding to the first workpiece sub-image.

In the foregoing, the first workpiece sub-image has the one or more first feature images, and each of the standard workpiece sub-images has the one or more of the predetermined feature points. The computing device further sets a first fixed point in the first workpiece sub-image, and respectively calculates relative to the first fixed point to obtain a plurality of coordinates of feature images corresponding to the first feature images. The computing device further sets a second fixed point in each of the standard workpiece sub-images, and respectively calculates relative to the second fixed point to obtain a plurality of coordinates of predetermined feature points corresponding to the one or more of the predetermined feature points in each of the standard workpiece sub-images. The computing device further obtains at least one of the standard workpiece sub-images that overlaps the first workpiece sub-image based on relative relationships between the coordinates of feature images and relative relationships between the coordinates of predetermined feature points.

In the foregoing, the computing device further identifies profiles of the one or more first feature images to respectively obtain one or more first feature configurations; generates one or more second feature configurations respectively based on profiles of the one or more of the predetermined feature points of each of the standard workpiece sub-images; and obtains at least one of the standard workpiece sub-images that overlaps the first workpiece sub-image based on the one or more first feature configurations and the one or more second feature configurations.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a simple schematic diagram of a system for inspecting conductive features of a workpiece according to various embodiments of this invention;

FIG. 2A depicts a bottom view of a workpiece in a system for inspecting conductive features of a workpiece according to various embodiments of this invention;

FIG. 2B depicts a schematic diagram of a workpiece image according to various embodiments of this invention;

FIG. 3A depicts a bottom view of a workpiece in a system for inspecting conductive features of a workpiece according to other embodiments of this invention;

FIG. 3B depicts a schematic diagram of a first workpiece sub-image according to other embodiments of this invention;

FIG. 4 to FIG. 6 depict simple schematic diagrams of standard workpiece images according to various embodiments of this invention;

FIG. 7 depicts a flowchart of a method for locating a workpiece according to various embodiments of this invention; and

FIG. 8 depicts a flowchart of a method for inspecting conductive features of a workpiece according to various embodiments of this invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

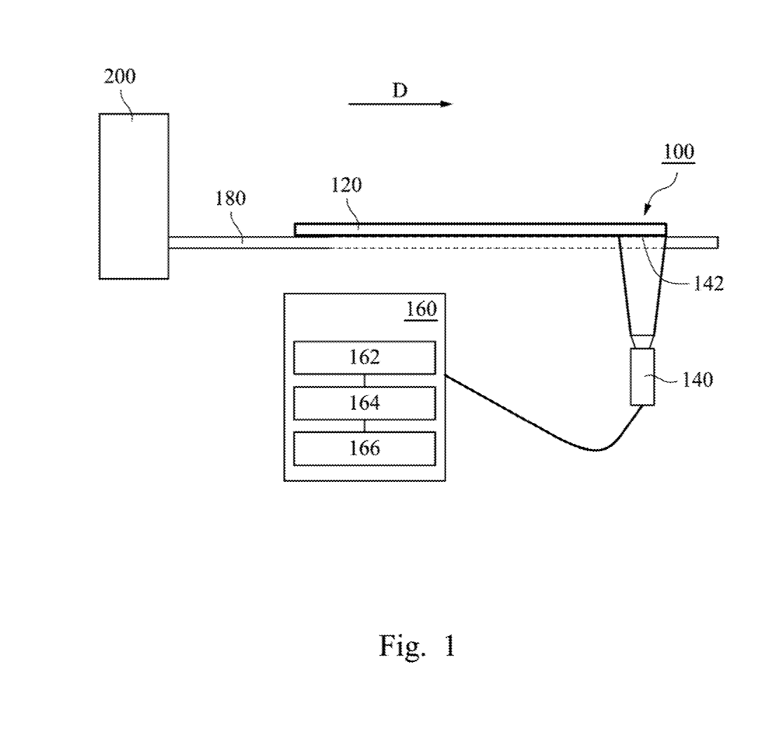

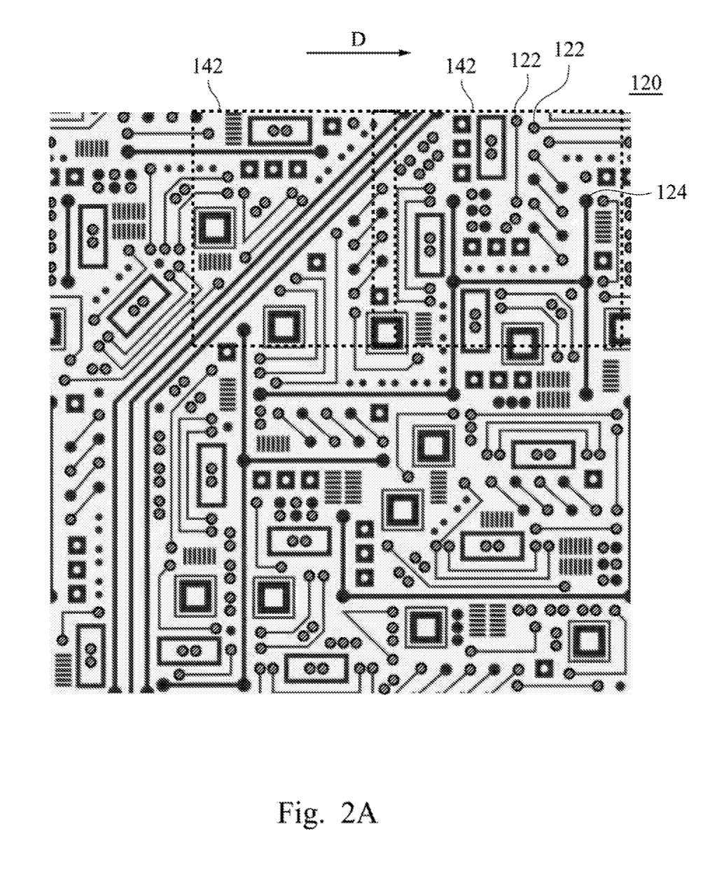

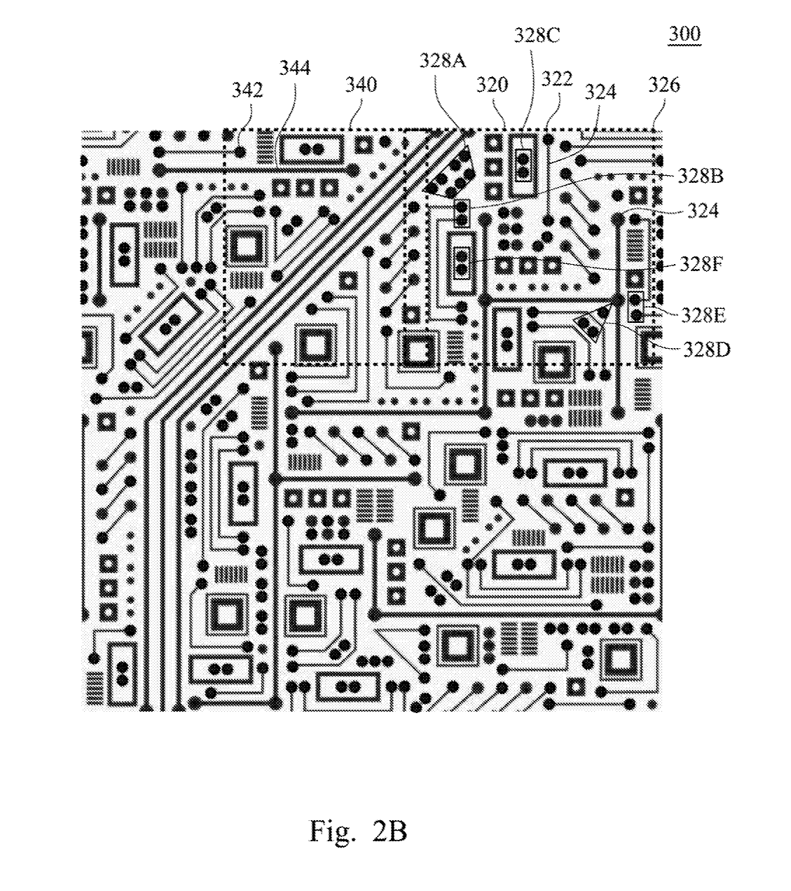

FIG. 1 depicts a simple schematic diagram of a system for inspecting conductive features of a workpiece 100 according to various embodiments of this invention. FIG. 2A depicts a bottom view of a workpiece 120 in the system for inspecting conductive features of the workpiece 100 according to various embodiments of this invention. As shown in FIG. 1, the system for inspecting conductive features of the workpiece 100 may comprise the workpiece 120, a video capture tool 140, a computing device 160, and a production line 180. A description is provided with reference to FIG. 2A. In various embodiments, the workpiece 120 may comprise conductive features formed on a surface of the workpiece 120. In other embodiments, patterned circuits 124 may be formed first then followed by formation of the conductive features 122 on the workpiece 120. In various embodiments, the conductive features 122 may be connected between the patterned circuits 124. In various embodiments, a material of the conductive features 122 may be tin, a tin alloy, a tin-free solder, or some other suitable soldering material.

FIG. 2B depicts a schematic diagram of a workpiece image 300 according to various embodiments of this invention. The workpiece image 300 corresponds to the workpiece 120, and a first workpiece sub-image 320 is a part of the workpiece image 300 corresponding to a field of view 142. A description is provided with reference to FIG. 1, FIG. 2A, and FIG. 2B. The video capture tool 140 can have the field of view 142. The video capture tool 140 is so disposed that the first workpiece sub-image 320 is captured in the field of view 142 when the workpiece 120 enters into the field of view 142. In various embodiments, the video capture tool 140 may capture the first workpiece sub-image 320 from a bottom of the workpiece 120, but the present invention is not limited in this regard. In greater detail, it is within the scope of the present invention as long as the video capture tool 140 can videograph the workpiece 120 from a direction which the first workpiece sub-image 320 of the workpiece 120 can be captured. In various embodiments, the first workpiece sub-image 320 may have one or more first feature images 322 respectively corresponding to one or more of the conductive features 122. In other embodiments, the first workpiece sub-image 320 may further have one or more first patterned circuit images 324 respectively corresponding to one or more of the patterned circuits 124. In one embodiment, the video capture tool 140 may be an industrial camera, but the present invention is not limited in this regard.

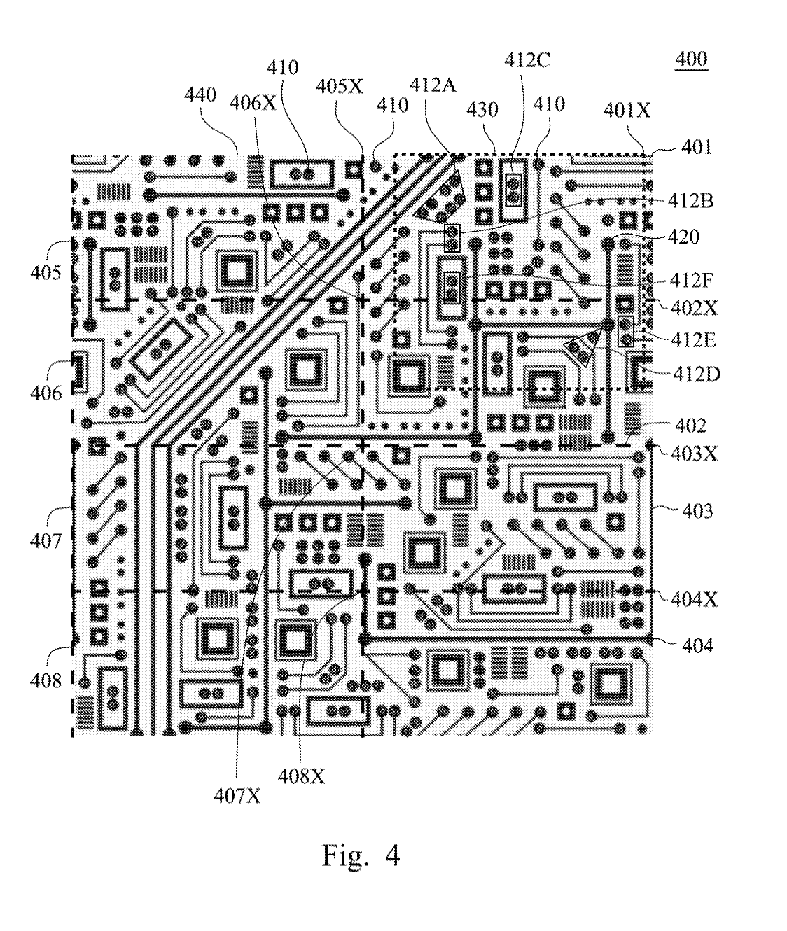

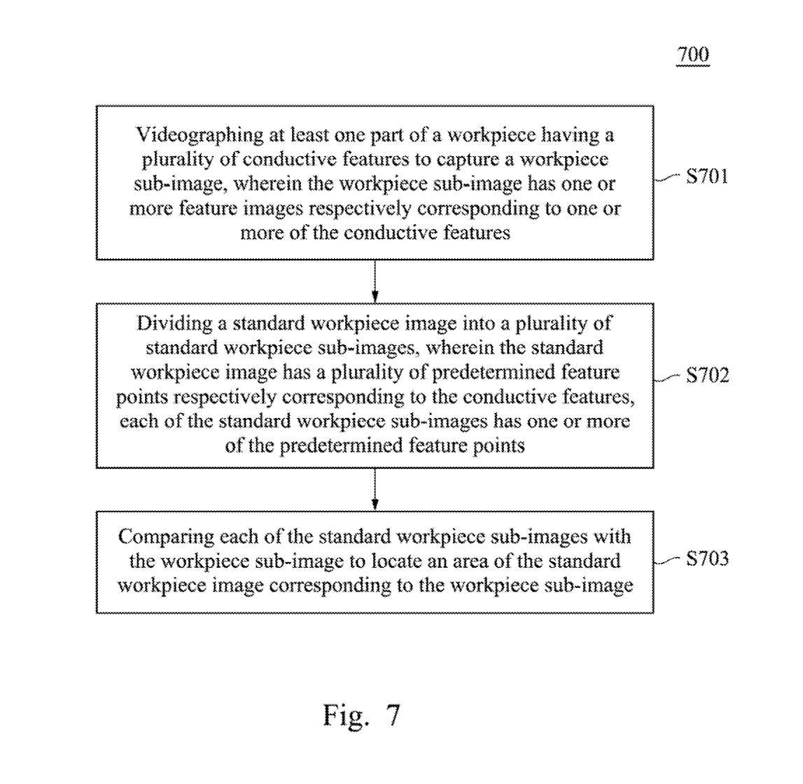

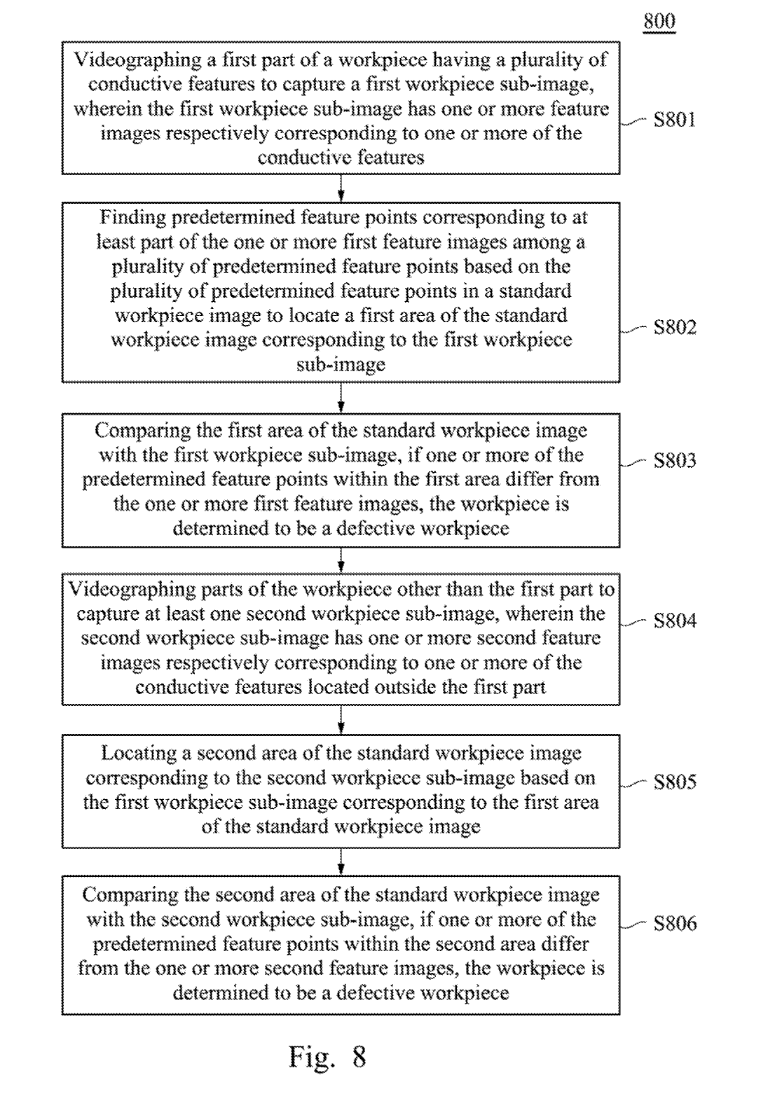

FIG. 4 depicts a simple schematic diagram of a standard workpiece image 400 according to various embodiments of this invention. A description is provided with reference to FIG. 1, FIG. 2B, and FIG. 4. In various embodiments, the computing device 160 may have a first program 162 and a second program 164. In various embodiments, the first program 162 can be configured to find predetermined feature points 410 corresponding to at least part of the one or more first feature images 322 in FIG. 2B based on a plurality of predetermined feature points 410 in the standard workpiece image 400 of FIG. 4 so as to locate a first area 430 of the standard workpiece image 400 corresponding to the first workpiece sub-image 320. The method for finding and locating may be achieved through, for example, steps S701 to S703 in FIG. 7 or steps S801 to S803 in FIG. 8. A detailed description is provided as follows, but the present invention is not limited in this regard. In various embodiments, the second program 164 can be configured to compare the first area 430 of the standard workpiece image 400 with the first workpiece sub-image 320. If one or more of the predetermined feature points 410 within the first area 430 are substantially corresponding to the one or more first feature images 322, the workpiece 120 is determined to be a normal workpiece.

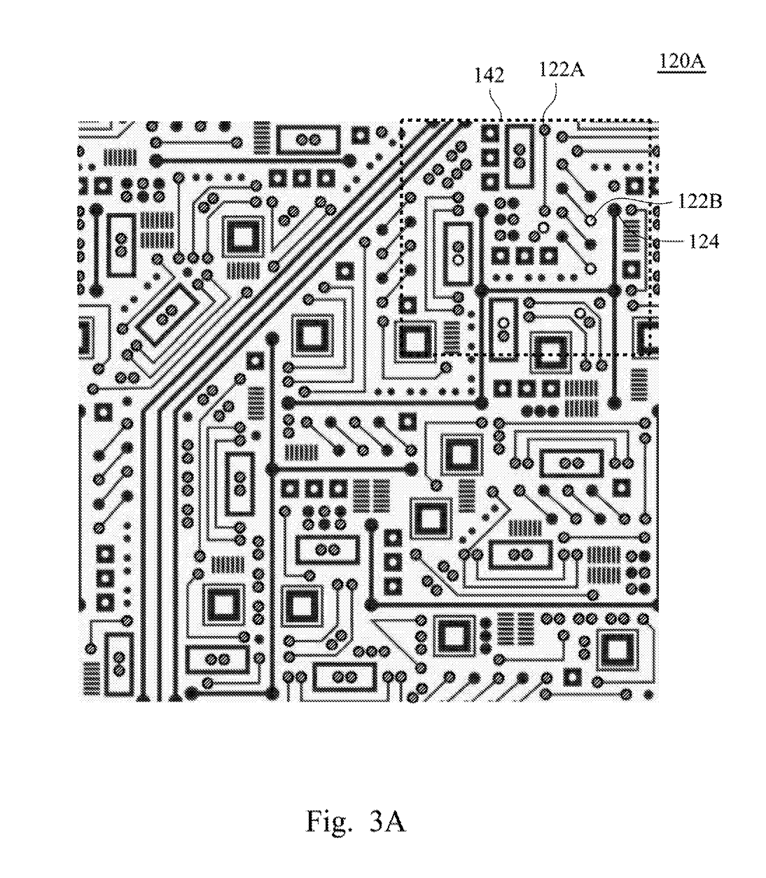

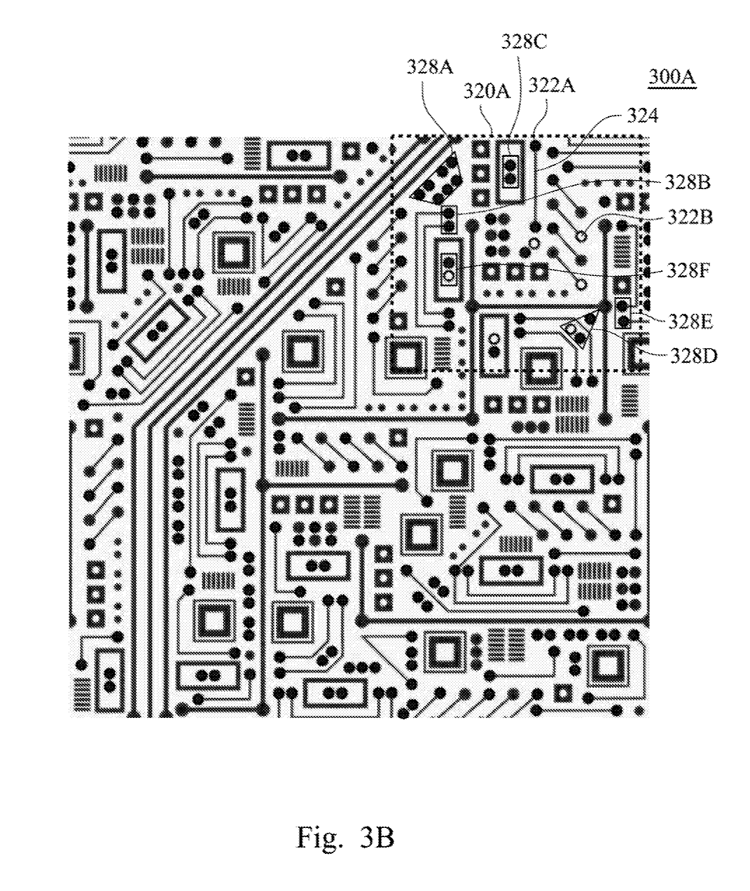

FIG. 3A depicts a bottom view of a workpiece 120A in the system for inspecting conductive features of the workpiece 100 according to other embodiments of this invention. FIG. 3B depicts a schematic diagram of a first workpiece sub-image 320A according to other embodiments of this invention. A workpiece image 300A corresponds to the workpiece 120A, and the first workpiece sub-image 320A is a part of the workpiece image 300A corresponding to the field of view 142. A description is provided with reference to FIG. 3A, FIG. 3B, and FIG. 4. As shown in FIG. 3A, in various embodiments, the workpiece 120A may comprise normal conductive features 122A and at least one defective or omitted conductive feature 122B. Correspondingly, the first workpiece sub-image 320A generated based on the workpiece 120A in the field of view 142 may have first feature images 322A and at least one first feature image 322B respectively corresponding to the normal conductive features 122A and the defective or omitted conductive feature 122B. Hence, when the computing device 160 compares the first area 430 of the standard workpiece image 400 with the first workpiece sub-image 320 through the second program 164, it will determine that the one or more of the predetermined feature points 410 within the first area 430 differ from one or more first feature images 322A, 322B in the first workpiece sub-image 320, for example, the first feature images 322B. As a result, the computing device 160 can determine that the workpiece 120A is a defective workpiece.

Since the system for inspecting conductive features of the workpiece 100 can capture the first workpiece sub-image 320 of the workpiece 120 or the first workpiece sub-image 320A of the workpiece 120A through the video capture tool 140, and process the first workpiece sub-images 320, 320A through the first program 162 and the second program 164 of the computing device 160, it is able to determine the difference between the first feature images 322, 322A, 322B of the first workpiece sub-images 320, 320A and the predetermined feature points 410 within the first area 430 of the standard workpiece image 400. Moreover, the system for inspecting conductive features of the workpiece 100 can be configured to determine whether the workpiece 120 or the workpiece 120A is a normal workpiece or a defective workpiece. Even more, the system for inspecting conductive features of the workpiece 100 can provide a position of the defective or omitted conductive feature 122B in the workpiece 120A that is a defective workpiece to further remove or repair the defect. As a result, automated processes can be used to provide a better defect detection rate. In practical applications, coordinate values in a CAD file (that is, a design file for manufacturing the workpiece 120) can be utilized to generate a desired image file, and then the desired image file and the image captured by the video capture tool 140 are binarized to compare the difference between the images and present statistics on the difference between the images. After that, an optimum value is found to serve as the best solution for locating.

Additionally, since the computing device 160 synchronously finds the difference between the one or more first feature image 322, 322A, 322B in the first workpiece sub-images 320, 320A and the one or more of the predetermined feature points 410, the time spent in determining the normal workpiece or the defective workpiece can be saved as compared with the algorithm method in which each of the first feature images 322, 322A, 322B is compared with each of the predetermined feature points 410 separately. For example, within a range of the first workpiece sub-images 320, the computational complexity of this question can be reduced from O(nⁿ) to O(n!), or to a even lower computational complexity. Therefore, the system for inspecting conductive features of the workpiece 100 can be applied to the production line that has a faster rate. Even more, the production line 180 may be a fully automated production line.

A description is provided with reference to FIG. 1, FIG. 2A, and FIG. 2B. In other embodiments, the production line 180 of the system for inspecting conductive features of the workpiece 100 may have a production direction D. The workpiece 120 can be placed on the production line 180, and the production line 180 pushes the workpiece 120 to advance in the production direction D. The video capture tool 140 can be further configured to capture at least one second workpiece sub-image 340 of the workpiece 120 in the field of view 142 in chronological order. The second workpiece sub-image 340 is at least partially different from the first workpiece sub-image 320. In various embodiments, the second workpiece sub-image 340 has one or more second feature images 342 corresponding to one or more of the conductive features 122. In other embodiments, the second workpiece sub-image 340 may further have one or more second patterned circuit images 344 corresponding to one or more of the patterned circuits 124.

A description is provided with reference to FIG. 1, FIG. 2B, and FIG. 4. In other embodiments, the computing device 160 may further have a third program 166 configured to locate a second area 440 of the standard workpiece image 400 corresponding to the second workpiece sub-image 340 based on the first workpiece sub-image 320 of FIG. 2B corresponding to the first area 430 of the standard workpiece image 400 in FIG. 4. For example, the second area 440 can be obtained through shifting from the first area 430, but the present invention is not limited in this regard. After that, the second area 440 of the standard workpiece image 400 and the second workpiece sub-image 340 are compared. Similar to the second program 164, if there is no difference between the predetermined feature points 410 within the second area 440 and the second feature images 342, the workpiece 120 is determined to be a normal workpiece. Conversely, if there is a difference between the predetermined feature points 410 within the second area 440 and the second feature images 342, the workpiece 120 is determined to be a defective workpiece.

With additional reference to FIG. 1. In other embodiments, the system for inspecting conductive features of the workpiece 100 may further be connected with a piece of equipment for manufacturing conductive features 200. After the conductive features 122 on the workpiece 120 are manufactured in the equipment for manufacturing conductive features 200, the conductive features 122 enter into the field of view 142 of the video capture tool 140 through the production line 180. After the video capture tool 140 and the computing device 160 cooperatively work, the workpiece 120 can be determined to be a normal workpiece or a defective workpiece.

FIG. 7 depicts a flowchart of a method for locating a workpiece 700 according to various embodiments of this invention. A description is provided with reference to FIG. 2A, FIG. 2B, FIG. 4, and FIG. 7. The method for locating the workpiece 700 starts from step S701. In step S701, at least one part of the workpiece 120 having the plurality of conductive features 122 as shown in FIG. 2A is videographed. For example, the first workpiece sub-image 320 of FIG. 2B is captured in the field of view 142 of FIG. 2A. In various embodiments, the first workpiece sub-image 320 may have the first feature images 322 respectively corresponding to the conductive features 122. In some embodiments, the first workpiece sub-image 320 may further have the first patterned circuit images 324 respectively corresponding to the patterned circuits 124. In some embodiments, the conductive features 122 may be the defective or omitted conductive feature 122B shown in FIG. 3B. Under the circumstances, the defective first feature images 322B will be generated in the captured first workpiece sub-image 320A correspondingly.

It is noted that the defective or omitted conductive feature 122B and the defective first feature image 322B depicted herein are only illustrative and are not intended to limit the present invention. For example, the defective or omitted conductive feature 122B may be bridged to the conductive feature 122, and the defective first feature image 322B can show the electrical connection relationship between the defective or omitted conductive feature 122B and the conductive feature 122 correspondingly. It should be understood that those of ordinary skill in the art may make equivalent modifications and variations depending on practical needs without departing from the scope or spirit of the present disclosure. It is within the scope of the present invention as long as the first feature images 322 of the first workpiece sub-image 320 can truly convey the electrical connection relationship between the conductive features 122. Even more, in some embodiments, it is within the scope of the present invention as long as the first feature image 322 and the first patterned circuit image 324 of the first workpiece sub-image 320 can truly convey the electrical connection relationship between the conductive feature 122 and the patterned circuit 124.

A description is provided with reference to FIG. 4 and FIG. 7. Then, the method for locating the workpiece 700 can proceed to step S702. In step S702, the standard workpiece image 400 is divided into a plurality of standard workpiece sub-images 401-408. The standard workpiece image 400 has the plurality of predetermined feature points 410 respectively corresponding to the conductive features 122. In greater detail, in some embodiments, the standard workpiece image 400 may be a design file for manufacturing the workpiece 120, such as a CAD file or the like, which generates the predetermined feature points 410 by using predetermined virtual positions for disposing the conductive features 122 of the workpiece 120. In some embodiments, the standard workpiece image 400 may be an image file for the workpiece 120 that is normal. The predetermined feature points 410 are generated by using the conductive features 122 of the workpiece 120 that is normal correspondingly. Each of the standard workpiece sub-images 401-408 may have one or more of the predetermined feature points 410. In some embodiment, step S702 may be performed prior to step S701.

A description is provided with reference to FIG. 2B, FIG. 4, and FIG. 7. After that, the method for locating the workpiece 700 can proceed to step S703. In step S703, the standard workpiece sub-images 401-408 and the first workpiece sub-image 320 are compared to locate an area of the standard workpiece image 400 to which the first workpiece sub-image 320 corresponds. For example, after comparison, it is known that both the standard workpiece sub-images 401, 402 partially overlap the first workpiece sub-image 320. Then, the area of the standard workpiece image 400 which is corresponded by the first workpiece sub-image 320 crosses two images of the standard workpiece sub-images 401, 402. The area of the standard workpiece image 400 for example, may correspond to the first area 430 that crosses the standard workpiece sub-images 401, 402.

A description is provided with reference to FIG. 2B and FIG. 4. In some embodiments, the first workpiece sub-image 320 may have the one or more first feature images 322. Each of the standard workpiece sub-images 401-408 may have the one or more of the predetermined feature points 410. In step S703, the first feature images 322 and the predetermined feature points 410 of the standard workpiece sub-images 401-408 can be respectively coordinated. Then, the standard workpiece sub-images 401-408 and the first workpiece sub-image 320 are compared based on relative relationships between the coordinated first feature images 322 and relative relationships between the coordinated predetermined feature points 410. For example, a first fixed point 326 may be set in the first workpiece sub-image 320, and a plurality of coordinates of feature images corresponding to the first feature images 322 can be obtained by respectively calculating relative to the first fixed point 326. Second fixed points 401x-408x are respectively set in the standard workpiece sub-images 401-408, and coordinates of predetermined feature points corresponding to the predetermined feature points 410 in the standard workpiece sub-images 401-408 are respectively obtained relative to the second fixed points 401x-408x. After that, the relative relationships between the coordinates of feature images and the relative relationships between the coordinates of predetermined feature points are calculated to obtain any of the standard workpiece sub-images 401-408 that at least partially overlaps the first workpiece sub-image 320, for example, the standard workpiece sub-images 401, 402. In some embodiments, the coordinates of feature images can be arrayed to calculate correlation coefficients between the matrixed coordinates of feature images and matrixed coordinates of predetermined feature points in a matrix space so as to find portions of the standard workpiece sub-images 401-408 that the first workpiece sub-image 320 overlaps. In some embodiments, the adjacent coordinates of feature images can be used to respectively form one or more triangles, scaled or rotated with an equal scale, and are compared with one or more triangles formed by adjacent coordinates of predetermined feature points to generate correlation coefficients correspondingly so as to find portions of the standard workpiece sub-images 401-408 that the first workpiece sub-image 320 overlaps. However, the present invention is not limited in this regard. For example, the comparison can be performed through a convolution neural network or some other image computing algorithm.

In some embodiments, in step S703, the one or more first feature images 322 may be respectively covered by a profile, and one or more first feature configurations 328A, 328B, 328C, 328D, 328E can be respectively obtained by identifying profile configurations of the one or more first feature images 322. In addition, the one or more of the predetermined feature points 410 of each of the standard workpiece sub-images 401-408 may be respectively covered by a profile, and one or more second feature configurations 412A, 412B, 412C, 412D, 412E can be respectively generated by identifying profile configurations of the one or more of the predetermined feature points 410 of each of the standard workpiece sub-images 401-408. After that, a comparison is performed to find any of the standard workpiece sub-images 401-408 that at least partially overlaps the first workpiece sub-image 320 based on the first feature configurations 328A, 328B, 328C, 328D, 328E and the second feature configurations 412A, 412B, 412C, 412D, 412E. For example, in some embodiments, configurations of and relative relationships between the first feature configurations 328A, 328B, 328C can be compared with configurations of and relative relationships between the second feature configurations 412A, 412B, 412C, and the first feature configurations 328D, 328E can be compared with the second feature configurations 412D, 412E so as to determine that the first workpiece sub-image 320 at least partially overlaps the standard workpiece sub-images 401, 402. In some embodiments, the first patterned circuit images 324 and predetermined patterned circuits 420 may be further added to the profile configurations respectively to serve as fixed points for comparison so as to compare relative positions of the first feature images 322 and each of the predetermined feature points 410.

In other embodiments, the step of locating the area of the standard workpiece image 400 to which the first workpiece sub-image 320 corresponds may be performed without dividing the standard workpiece image 400. For example, if the configurations of the conductive features 122 are simple and different geometric patterns, such as a rectangle, a circle, or a matrix of columns and rows, a distribution of the conductive features 122 can be quickly compared and determined without dividing the standard workpiece image 400. Even more, in other embodiments, the field of view 142 may substantially cover the whole workpiece 120.

FIG. 8 depicts a flowchart of a method for inspecting conductive features of a workpiece 800 according to various embodiments of this invention. A description is provided with reference to FIG. 3A, FIG. 3B, FIG. 4 and FIG. 8. The method for inspecting conductive features of the workpiece 800 starts from step S801. In step S801, a first part of the workpiece 120A having the plurality of conductive features 122A, 122B as shown in FIG. 3A is videographed. For example, the first workpiece sub-image 320A of FIG. 3B is captured in the field of view 142 of FIG. 3A. In various embodiments, the first workpiece sub-image 320A may have the first feature images 322A, 322B respectively corresponding to the normal conductive features 122A and the defective or omitted conductive feature 122B. In some embodiments, the first workpiece sub-image 320A may have the first patterned circuit images 324 respectively corresponding to the patterned circuits 124.

A description is provided with reference to FIG. 3B, FIG. 4, and FIG. 8. After that, the method for inspecting conductive features of the workpiece 800 can proceed to step S802. In step S802, the predetermined feature points 410 corresponding to at least part of the one or more first feature images 322A, 322B are found based on the plurality of predetermined feature points 410 in the standard workpiece image 400 so as to locate the first area 430 of the standard workpiece image 400 corresponding to the first workpiece sub-image 320A. In greater detail, since the predetermined feature points 410 of the standard workpiece image 400 can be corresponding to predetermined virtual positions for disposing the conductive features 122 of the workpiece 120 or actual positions of the conductive features 122 of the workpiece 120 that is normal, they can also be corresponding to the first feature images 322A generated by the normal conductive features 122A. For example, in various embodiments, the standard workpiece image 400 may be divided into the plurality of standard workpiece sub-images 401-408. Each of the standard workpiece sub-images 401-408 may have the one or more of the predetermined feature points 410 configured to be compared with the first feature images 322A of the first workpiece sub-image 320A so as to locate the first area 430 of the standard workpiece image 400 corresponding to the first workpiece sub-image 320.

A description is provided with reference to FIG. 3B and FIG. 4. In some embodiments, the first workpiece sub-image 320A has the plurality of first feature images 322A and the at least one first feature image 322B. Each of the standard workpiece sub-images 401-408 may have the one or more of the predetermined feature points 410. In step S802, the first feature images 322A and the predetermined feature points 410 of each of the standard workpiece sub-images 401-408 can be respectively coordinated. Then, the standard workpiece sub-images 401-408 and the first workpiece sub-image 320A are compared based on relative relationships between the coordinated first feature images 322A and relative relationships between the coordinated predetermined feature points 410. However, the predetermined feature points 410 actually comprise a position for disposing the at least one defective or omitted conductive feature 122B so the predetermined feature points 410 can not completely correspond to the first feature images 322A one on one. As a result, in some embodiments, locating can only be achieved through using the first feature images 322A partially corresponding to the predetermined feature points 410. In some embodiments, the locating can be achieved through the first feature images 322A and part of the first feature images 322B if appearances of part of the defective or omitted conductive feature 122B do not interfere with the determination.

For example, a first fixed point 326A may be set in the first workpiece sub-image 320A, and a plurality of coordinates of feature images corresponding to the first feature images 322A and the first feature image 322B are respectively calculated relative to the first fixed point 326A. In various embodiments, the first feature images 322 generated by the normal conductive features 122 can be used to compare and identify the first feature images 322A and the first feature image 322B and separately record the coordinates of feature images correspondingly for subsequent search of the defective or omitted conductive feature 122B. Then, the second fixed points 401x-408x may be respectively set in the standard workpiece sub-images 401-408, and coordinates of predetermined feature points corresponding to the predetermined feature points 410 in the standard workpiece sub-images 401-408 are respectively obtained relative to the second fixed points 401x-408x. After that, the relative relationships between the coordinates of feature images generated by the first feature images 322A and the relative relationships between the coordinates of predetermined feature points are used to calculate so as to obtain any of the standard workpiece sub-images 401-408 that at least partially overlaps the first workpiece sub-image 320A, for example, the standard workpiece sub-images 401, 402.

In some embodiments, the coordinates of feature images can be arrayed to calculate correlation coefficients between the matrixed coordinates of feature images and matrixed coordinates of predetermined feature points in a matrix space so as to find portions of the standard workpiece sub-images 401-408 that the first workpiece sub-image 320A overlaps. In some embodiments, the adjacent coordinates of feature images can be used to respectively form one or more triangles, scaled or rotated with an equal scale, and are compared with one or more triangles formed by adjacent coordinates of predetermined feature points to generate correlation coefficients correspondingly so as to find portions of the standard workpiece sub-images 401-408 that the first workpiece sub-image 320A overlaps. However, the present invention is not limited in this regard. For example, the comparison can be performed through a convolution neural network or some other image computing algorithm. It should be understood that because the coordinates of feature images corresponding to at least part of the first feature images 322B are probably lost in the coordinates of feature images, the coordinates of feature images can not correspond to the coordinates of predetermined feature points one on one. Hence, the allowable range of the correlation coefficients needs to be adjusted, or a plurality of corresponding points that that still satisfy the limitation of correlation coefficients are searched so as to locate the first workpiece sub-image 320A.

In some embodiments, in step S802, the one or more first feature images 322A may be respectively covered by a profile, and one or more first feature configurations 328A, 328B, 328C, 328D, 328E, 328F can be respectively obtained by identifying profile configurations of the one or more first feature images 322. In addition, the one or more of the predetermined feature points 410 of each of the standard workpiece sub-images 401-408 may be respectively covered by a profile, and one or more second feature configurations 412A, 412B, 412C, 412D, 412E, 412F can be respectively generated by identifying profile configurations of the one or more of the predetermined feature points 410 of each of the standard workpiece sub-images 401-408. After that, the first feature configurations 328F, 328D having the first feature image 322B are excluded, and a comparison is performed to find any of the standard workpiece sub-images 401-408 that at least partially overlaps the first workpiece sub-image 320A based on the first feature configurations 328A, 328B, 328C, 328E and the second feature configurations 412A, 412B, 412C, 412E. For example, in some embodiments, configurations of and relative relationships between the first feature configurations 328A, 328B, 328C can be compared with configurations of and relative relationships between the second feature configurations 412A, 412B, 412C, and the first feature configuration 328E can be compared h the second feature configuration 412E so as to determine that the first workpiece sub-image 320A at least partially overlaps the standard workpiece sub-images 401, 402. In this method, since a profile configuration comprising the first feature image 322B probably differs from the profile configurations of the predetermined feature points 410, the configurations and relative relationships that still conform can be searched to perform the comparison when corresponding.

A description is provided with reference to FIG. 3A, FIG. 3B, and FIG. 8. Then, the method for inspecting conductive features of the workpiece 800 can proceed to step S803. In step S803, the first area 430 and the first workpiece sub-image 320A are compared. If the predetermined feature points 410 within the first area 430 differ from the first feature images 322A, 322B, the workpiece 120A is determined to be a defective workpiece. For example, the first feature image 322B substantially can not correspond to the predetermined feature point 410 so the workpiece 120 is a defective workpiece. Conversely, when steps S801-S803 are performed on the workpiece 120, the workpiece 120 can be determined to be a normal workpiece because all the first feature images 322 can be corresponding to the predetermined feature points 410.

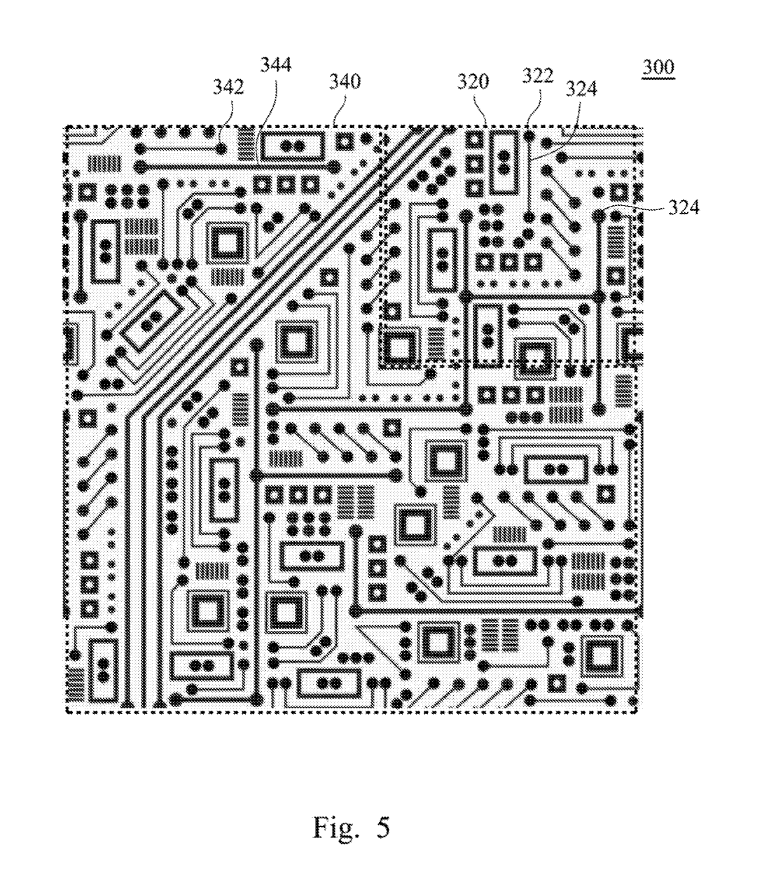

A description is provided with reference to FIG. 2A, FIG. 5 and FIG. 8. After that, the method for inspecting conductive features of the workpiece 800 can proceed to step S804. In step S804, a part of the workpiece 120 other than the first part, such as a part outside the field of view 142, is videographed so as to capture at least one second workpiece sub-image 340. In various embodiments, the second workpiece sub-image 340 has the second feature images 342 respectively corresponding to one or more of the conductive features 122 located outside the first part. In other embodiments, the second workpiece sub-image 340 may further have the second patterned circuit images 344 respectively corresponding to one or more of the patterned circuits 124 outside the first part. In various embodiments, the field of view 142 may be moved to capture the second workpiece sub-image 340. In other embodiments, the field of view 142 may cross the workpiece 120, and portions of the workpiece 120 that enter into the field of view 142 are sequentially captured when the workpiece 120 advances along the production direction D of the production line 180. However, the present invention is not limited in this regard.

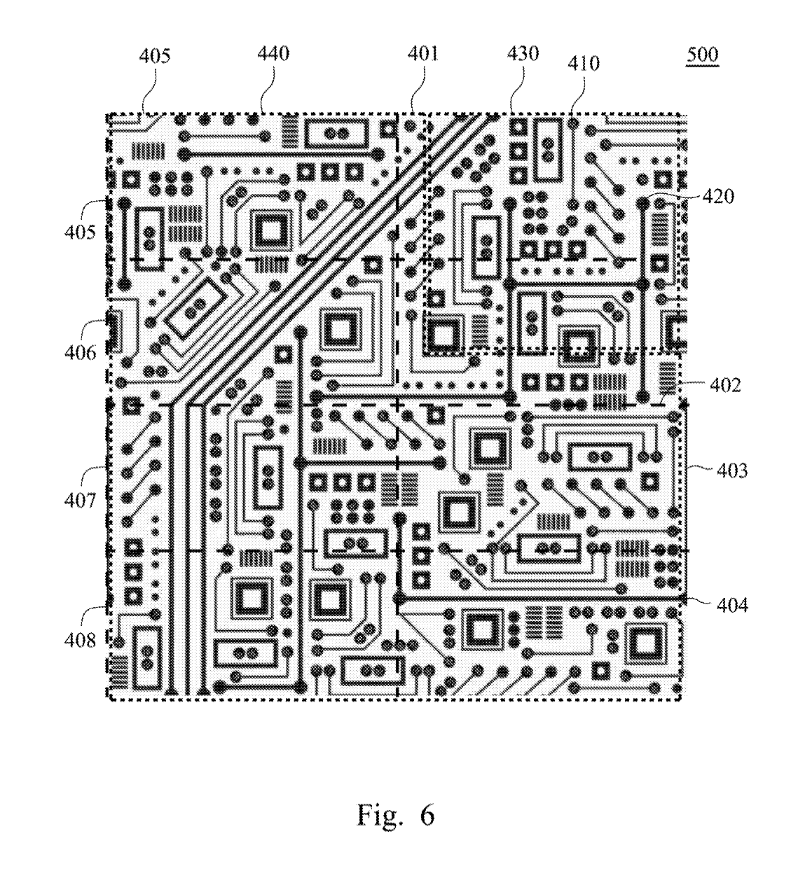

A description is provided with reference to FIG. 5, FIG. 6, and FIG. 8. Then, the method for inspecting conductive features of the workpiece 800 can proceed to step S805. In step S805, the second area 440 of a standard workpiece image 500 corresponding to the second workpiece sub-image 340 is located based on the first workpiece sub-image 320 corresponding to the first area 430 of the standard workpiece image 500. In some embodiments, since a positional relationship between the first area 430 and the standard workpiece image 500 is known, the second area 440 of the standard workpiece image 500 corresponding to the second workpiece sub-image 340 can be obtained through a geometric operation, such as a horizontal shift or a vertical shift. As a result, a large amount of comparison operations can be omitted to further save computing resources and obtain a shorter computing time so as to further improve the efficiency of the production line 180.

After that, the method for inspecting conductive features of the workpiece 800 can proceed to step S806. In step S806, similar to step S803, the second area 440 of the standard workpiece image 500 and the second workpiece sub-image 340 are compared. If the predetermined feature points 410 within the second area 440 differ from the second feature images 342, the workpiece 120 is determined to be a defective workpiece. Conversely, if the predetermined feature points 410 within the second area 440 are the same as the second feature images 342, the workpiece 120 is determined to be a normal workpiece.

In practical applications, the method for inspecting conductive features of the workpiece and the system for inspecting conductive features of the workpiece according to the present invention have the following effects: (1). The product CAD file (that is, the design file for manufacturing the workpiece 120) can be imported and data can be analyzed so that DIP data that is probably inspected in the future is processed in advance to be converted into available data of the inspection programs so as to reduce unnecessary time waste in loading programs; (2). Relative coordinate values (that is, the coordinates of predetermined feature points) extracted from the CAD file and images (that is, the workpiece images) directed captured by the video capture tool can be utilized so as to quickly locate DIP elements in the images for subsequent inspection; (3). The inspection can be immediately introduced for different models and different DIP elements; (4). The cost for maintenance personnel on the production line can be reduced by referring to information from the CAD file, and only a one-time adjustment is needed in the first introduction; and (5). As evident by software practices, take an image having a resolution of 3856×2764 for example, all the coordinate points in the image that need to be inspected can be located in less than one second, which is very suitable for fast inspection in the production flow.

In summary, the method for inspecting conductive features of the workpiece according to the present invention comprises: videographing at least one part of a workpiece having a plurality of conductive features to capture a workpiece sub-image, wherein the workpiece sub-image has one or more feature images respectively corresponding to one or more of the conductive features; dividing a standard workpiece image into a plurality of standard workpiece sub-images, wherein the standard workpiece image has a plurality of predetermined feature points respectively corresponding to the conductive features, and each of the standard workpiece sub-images has one or more of the predetermined feature points; and comparing each of the standard workpiece sub-images with the workpiece sub-image to locate an area of the standard workpiece image to which the workpiece sub-image corresponds. Since the standard workpiece image is divided into the plurality of standard workpiece sub-images having a smaller area and less predetermined feature points, and the standard workpiece sub-images are compared with the workpiece sub-image that is obtained by capturing image of part of the workpiece and has the features images corresponding to the conductive features, the computing amount and computing time for comparing the features images and the predetermined feature points can be reduced. In addition, the portions that have been located can be used as an anchor in subsequent comparison so as to generate a comparison result. As a result, the burden of the computing device and the length of computing time can be reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for inspecting conductive features of a workpiece comprising:
videographing a first part of a workpiece having a plurality of conductive features to capture a first workpiece sub-image, wherein the first workpiece sub-image has one or more first feature images respectively corresponding to one or more of the conductive features;
finding predetermined feature points corresponding to at least part of the one or more first feature images among a plurality of predetermined feature points based on the plurality of predetermined feature points in a standard workpiece image to locate a first area of the standard workpiece image corresponding to the first workpiece sub-image; and
comparing the first area of the standard workpiece image with the first workpiece sub-image, if one or more of the predetermined feature points within the first area differ from the one or more first feature images, the workpiece being determined to be a defective workpiece.

2. The method for inspecting conductive features of the workpiece of claim 1, wherein the step of finding the predetermined feature points corresponding to the at least part of the one or more first feature points among the plurality of predetermined feature points comprises:
dividing the standard workpiece image into a plurality of standard workpiece sub-images, wherein each of the standard workpiece sub-images has one or more of the predetermined feature points; and
comparing each of the standard workpiece sub-images with the first workpiece sub-image to locate the first area of the standard workpiece image corresponding to the first workpiece sub-image.

3. The method for inspecting conductive features of the workpiece of claim 2, wherein the first workpiece sub-image has the one or more first feature images, and each of the standard workpiece sub-images has the one or more of the predetermined feature points, wherein the step of finding the predetermined feature points corresponding to the at least part of the one or more first feature points among the plurality of predetermined feature points comprises:
setting a first fixed point in the first workpiece sub-image, and respectively calculating relative to the first fixed point to obtain a plurality of coordinates of first feature images corresponding to the first feature images;
setting a second fixed point in each of the standard workpiece sub-images, and respectively calculating relative to the second fixed point to obtain a plurality of coordinates of predetermined feature points corresponding to the one or more of the predetermined feature points in each of the standard workpiece sub-images; and
calculating relative relationships between the coordinates of first feature images and relative relationships between the coordinates of predetermined feature points to obtain at least one of the standard workpiece sub-images that overlaps the first workpiece sub-image.

4. The method for inspecting conductive features of the workpiece of claim 2, wherein the step of finding the predetermined feature points corresponding to the at least part of the one or more first feature points among the plurality of predetermined feature points comprises:
identifying profiles of the one or more first feature images to respectively obtain one or more first feature configurations;
generating one or more second feature configurations respectively based on profiles of the one or more of the predetermined feature points of each of the standard workpiece sub-images; and
comparing the one or more first feature configurations with the one or more second feature configurations to obtain at least one of the standard workpiece sub-images that overlaps the first workpiece sub-image.

5. The method for inspecting conductive features of the workpiece of claim 1, further comprising:
videographing parts of the workpiece other than the first part to capture at least one second workpiece sub-image, wherein the second workpiece sub-image has one or more second feature images respectively corresponding to one or more of the conductive features located outside the first part;
locating a second area of the standard workpiece image corresponding to the second workpiece sub-image based on the first workpiece sub-image corresponding to the first area of the standard workpiece image; and
comparing the second area of the standard workpiece image with the second workpiece sub-image, if one or more of the predetermined feature points within the second area differ from the one or more second feature images, the workpiece being determined to be a defective workpiece.

6. A system for inspecting conductive features of a workpiece comprising:
at least one workpiece having a plurality of conductive features;
at least one video capture tool having a field of view, the video capture tool being so disposed that a first workpiece sub-image is captured when the workpiece enters into the field of view, wherein the first workpiece sub-image has one or more first feature images respectively corresponding to one or more of the conductive features; and
a computing device finding predetermined feature points corresponding to at least part of the one or more first feature images among a plurality of predetermined feature points based on the plurality of predetermined feature points in a standard workpiece image to locate a first area of the standard workpiece image corresponding to the first workpiece sub-image, and the computing device comparing the first area of the standard workpiece image with the first workpiece sub-image, if one or more of the predetermined feature points within the first area differ from the one or more first feature images, the workpiece being determined to be a defective workpiece.

7. The system for inspecting conductive features of the workpiece of claim 6, wherein the computing device is further configured to divide the standard workpiece image into a plurality of standard workpiece sub-images, wherein each of the standard workpiece sub-images has one or more of the predetermined feature points; and compare each of the standard workpiece sub-images with the first workpiece sub-image to locate the first area of the standard workpiece image corresponding to the first workpiece sub-image.

8. The system for inspecting conductive features of the workpiece of claim 7, wherein the first workpiece sub-image has the one or more first feature images, and each of the standard workpiece sub-images has the one or more of the predetermined feature points, wherein the computing device sets a first fixed point in the first workpiece sub-image, and respectively calculates relative to the first fixed point to obtain a plurality of coordinates of feature images corresponding to the first feature images, and the computing device sets a second fixed point in each of the standard workpiece sub-images, and respectively calculates relative to the second fixed point to obtain a plurality of coordinates of predetermined feature points corresponding to the one or more of the predetermined feature points in each of the standard workpiece sub-images; and the computing device calculates relative relationships between the coordinates of feature images and relative relationships between the coordinates of predetermined feature points to obtain at least one of the standard workpiece sub-images that overlaps the first workpiece sub-image.

9. The system for inspecting conductive features of the workpiece of claim 7, wherein the computing device is further configured to identify profiles of the one or more first feature images to respectively obtain one or more first feature configurations; generate one or more second feature configurations respectively based on profiles of the one or more of the predetermined feature points of each of the standard workpiece sub-images; and compare the one or more first feature configurations with the one or more second feature configurations to obtain at least one of the standard workpiece sub-images that overlaps the first workpiece sub-image.

10. The system for inspecting conductive features of the workpiece of claim 6, further comprising a production line having a production direction, wherein the workpiece is placed on the production line and advances in the production direction, wherein the video capture tool captures at least one second workpiece sub-image of the workpiece in the field of view in chronological order, wherein the second workpiece sub-image has one or more second feature images and is at least partially different from the first workpiece sub-image, wherein the computing device locates a second area of the standard workpiece image corresponding to the second workpiece sub-image based on the first workpiece sub-image corresponding to the first area of the standard workpiece image, and compares the second area of the standard workpiece image with the second workpiece sub-image, if one or more of the predetermined feature points within the second area differ from the one or more second feature images, the workpiece is determined to be a defective workpiece.
